(19) United States
(12) Patent Application Publication
(10) Pub. No.: US 2020/0166276 A1
(43) Pub. Date: May 28, 2020

(54) COOKING APPLIANCE

(71) Applicant: WHIRLPOOL CORPORATION, BENTON HARBOR, MI (US)

(72) Inventors: Federico Garuccio, Milan (IT); Cristiano Vito Pastore, Novara (IT)

(73) Assignee: WHIRLPOOL CORPORATION, BENTON HARBOR, MI (US)

(21) Appl. No.: 16/202,534

(22) Filed: Nov. 28, 2018

(51) Int. Cl. F27D 21/02; F24C 7/08; F24C 15/00; F24C 15/02; F24C 15/16

(52) U.S. Cl. CPC F27D 21/02; F24C 7/085; F27D 2021/026; F24C 15/021; F24C 15/16; F24C 15/008

(57) ABSTRACT

A cooking appliance is provided that includes a casing defining a cooking cavity. The casing includes a top wall defining an aperture. A supporting member has an inner surface and defines an air channel and a sealed chamber with a first opening and a second opening. The second opening is aligned with the aperture of the top wall of the casing. A fan is coupled to the casing and is configured to selectively supply airflow along the inner surface. An imaging device assembly is positioned within the air channel of the supporting member and is aligned with the first opening of the chamber to view the cavity. The imaging device assembly is configured to seal the first opening. A transparent member is positioned proximate the second opening and is configured to seal the second opening.

### FIELD OF THE DISCLOSURE

The present disclosure generally relates to a cooling system, and more specifically to a cooling system for a camera located within a cooking appliance.

### BACKGROUND

Windows within an oven door may be used for checking food within the oven cavity. Users may view the food through the window or open the oven door to see into the cavity. Known oven appliances comprise an imaging device or camera facing the cooking cavity, e.g. associated with the oven door or arranged in a seat formed in the oven chassis. The use of imaging devices or cameras is advantageous in that it allows to improve food vision and control of a related cooking process. However, the operation of cameras arranged so as to face the cooking cavity of an oven may be compromised by the high temperatures characterizing a cooking process. This is particularly important in self-cleaning ovens, which exploit pyrolisys as a means to incinerate food residues in an oven cavity. It is known to supply airflow towards a camera in order to cool it during operation. However, a need exists to improve cooling in particular to preserve the camera lens.

### SUMMARY

In at least one feature, a cooking appliance is provided that includes a casing defining a cooking cavity. The casing includes a top wall defining an aperture. An imaging device assembly is configured to take imagery of the cavity interior. The imaging device assembly includes an imaging sensor and a plurality of lenses supported by a lens holder. The imaging device assembly is positioned so as to see through the aperture. A supporting member is at least partially made of an insulating material and defines a chamber having a peripheral wall, a first opening, and a second opening. The second opening is opposite the first opening. The lens holder is positioned proximate the first opening so that the plurality of lenses face the chamber. At least one transparent member is mounted at the second opening and is configured to seal the chamber relative to the cooking cavity. A fan is coupled to the casing proximate the aperture in the top wall. The fan is configured to selectively supply an airflow towards the lens holder of the imaging device assembly.

In at least another feature, a cooking appliance is provided that includes a casing defining a cooking cavity. The casing includes a top wall defining an aperture. A supporting member has a bottom wall with an inner surface and a perimeter wall at least partially integrally formed with the bottom wall. The bottom wall defines a sealed chamber with a first opening and a second opening. The second opening is aligned with the aperture of the top wall of the casing. A fan is coupled to the supporting member and is configured to selectively supply the airflow along the inner surface. An imaging device assembly is positioned within the air channel of the supporting member such that a lens of the imaging device assembly is aligned with the first opening of the chamber to view the cavity. The imaging device assembly is at least partially supported by a bracket.

In at least another feature, a cooking appliance is provided that includes a casing defining a cooking cavity. The casing includes a top wall defining an aperture. A supporting member has an inner surface and defines an air channel and a sealed chamber with a first opening and a second opening. The second opening is aligned with the aperture of the top wall of the casing. A fan is coupled to the casing and is configured to selectively supply airflow along the inner surface. An imaging device assembly is positioned within the air channel of the supporting member and is aligned with the first opening of the chamber to view the cavity. The imaging device assembly is configured to seal the first opening. A transparent member is positioned proximate the second opening and is configured to seal the second opening.

These and other features, advantages, and objects of the present device will be further understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a front perspective view of a body of a cooking appliance with a door shown in phantom;

FIG. 2 is a bottom perspective view of the body of the cooking appliance of FIG. 1 with an opening defined by a top wall;

FIG. 3 is a partial cross-sectional view of the body of the cooking appliance taken along line III-III of FIG. 1 with a housing and an imaging device;

FIG. 4 is a side perspective view of the body of the cooking appliance of FIG. 1 with a housing, an imaging device, and a fan;

FIG. 5 is a side perspective view of the body of the cooking appliance of FIG. 4 with an exterior plate;

FIG. 6 is a cross-sectional view of the housing of FIG. 4;

FIG. 7 is a cross-sectional view of the housing of FIG. 6 according to various examples;

FIG. 8 is a cross-sectional view of the housing of FIG. 6 according to various examples; and

FIG. 9 is a block diagram of a controller of the appliance of FIG. 1.

### DETAILED DESCRIPTION OF EMBODIMENTS

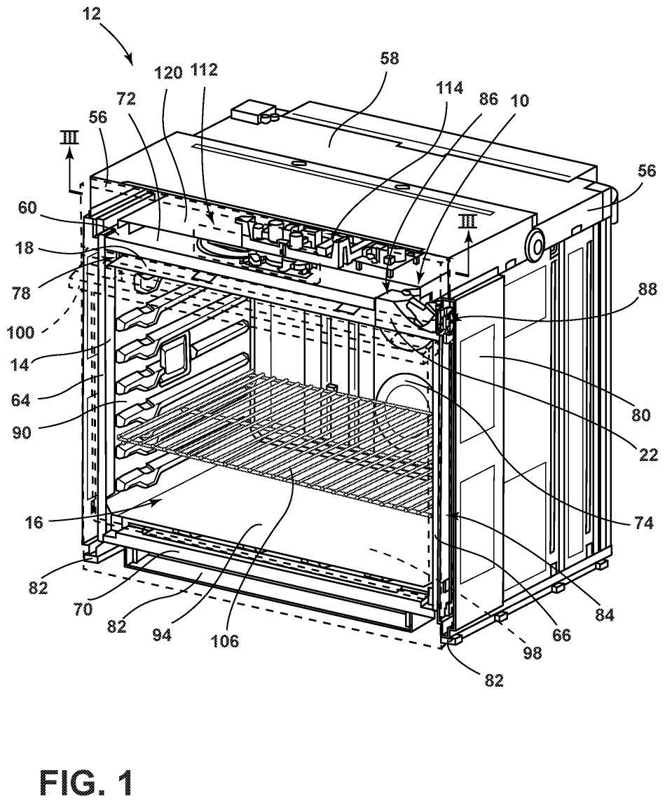

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As required, detailed examples of the present disclosure are disclosed herein. However, it is to be understood that the disclosed examples are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a cooling system for an imaging device positioned within an appliance and configured to provide images of a cooking cavity. The imaging device is positioned within a void of a housing and aligned with various openings to allow a lens of the imaging device to view the interior of the cooking cavity. A fan is positioned to circulate air around the housing and cool the imaging device.

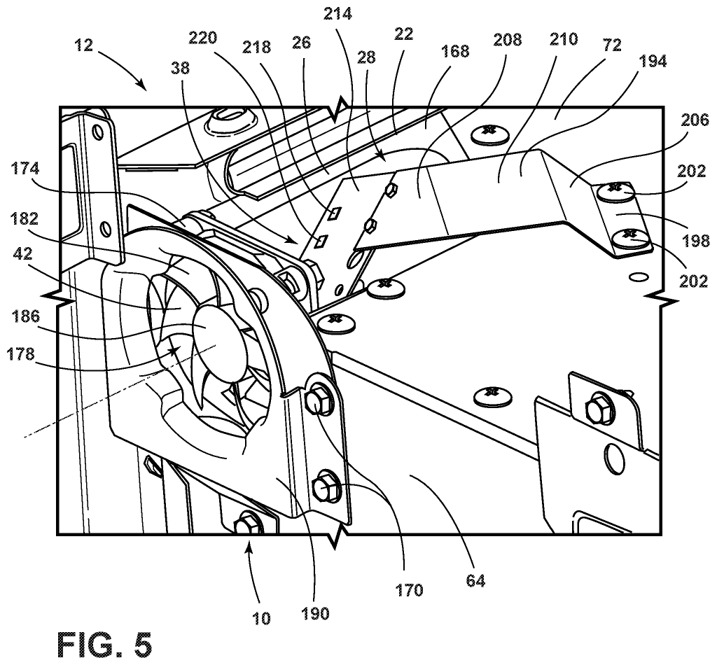

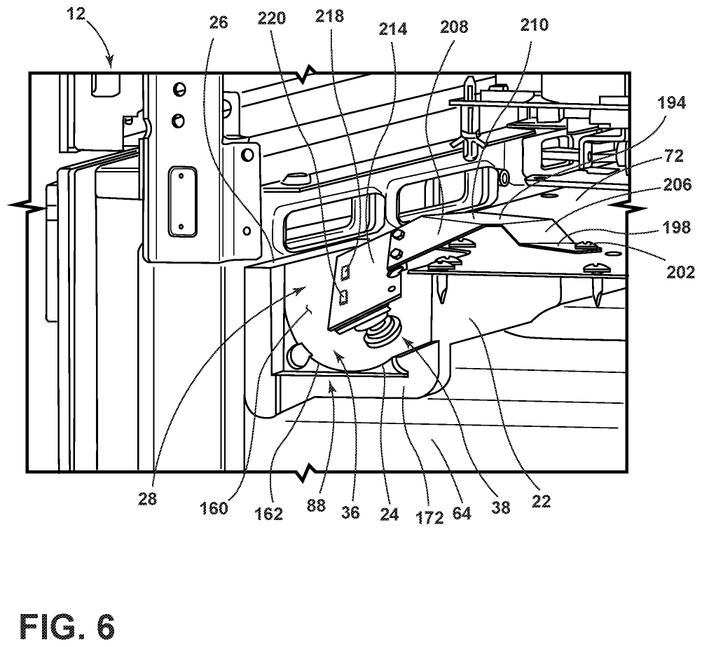

Referring to the embodiment illustrated in FIGS. 1-8, reference numeral 10 generally designates a cooling system for a cooking appliance 12 including a casing 14 defining a cooking cavity 16. The casing 14 includes a top wall 18 defining an aperture 20. A supporting member 22 includes a bottom wall 24 and a perimeter wall 26. Together the perimeter wall 26 and the bottom wall 24 define an air channel 28. The bottom wall 24 defines a chamber 30 having a first opening 32 and a second opening 34. The second opening 34 is aligned with the aperture 20 of the top wall 18. The perimeter wall 26 defines an opening 36 in communication with the air channel 28. An imaging device assembly 38, e.g. a camera, is positioned within the air channel 28 of the supporting member 22 such that a lens 40 of the imaging device assembly 38 is aligned with the first opening 32 of the chamber 30. A fan 42 is positioned within the opening 36 of the perimeter wall 26 of the supporting member 22.

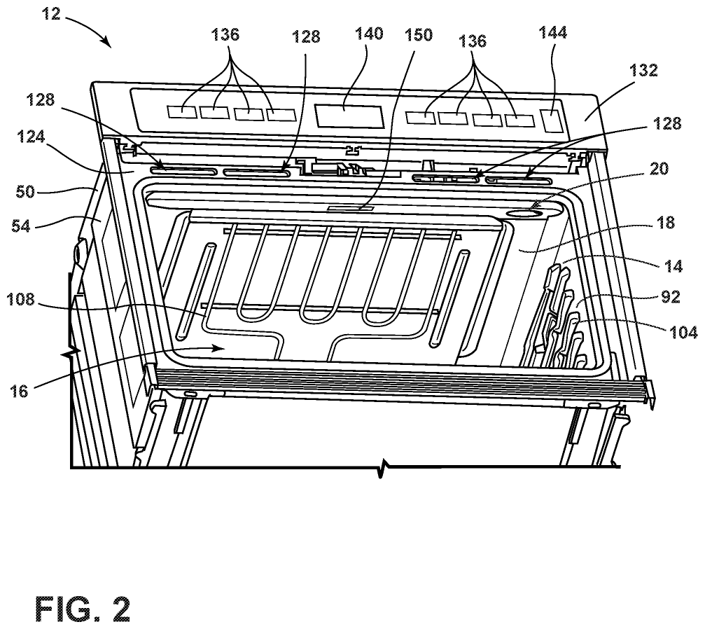

Referring now to FIGS. 1 and 2, the cooking appliance 12 is exemplarily shown as an oven. The cooking appliance 12 may be a component of a free-standing range or may be embodied as an in-wall oven assembly, a double oven assembly, or any other cooking appliance assembly without departing from the scope of the present disclosure. The cooking appliance 12 utilizes a self-cleaning feature that allows the cooking appliance 12 to reach temperatures up to about 450° C. When the cooking appliance 12 reaches 450° C. or other high temperatures, the cooling system 10 may be used to protect the imaging device assembly 38.

The cooking appliance 12 includes an appliance body 60. The body 60 includes a first side wall 64 and a second side wall 66 joined by a lower wall 70 and an upper wall 72. A back wall 74 connects the first and second side walls 64, 66, the lower wall 70, and the upper wall 72 to define a body cavity 78. According to various examples, the appliance body 60 may be insulated.

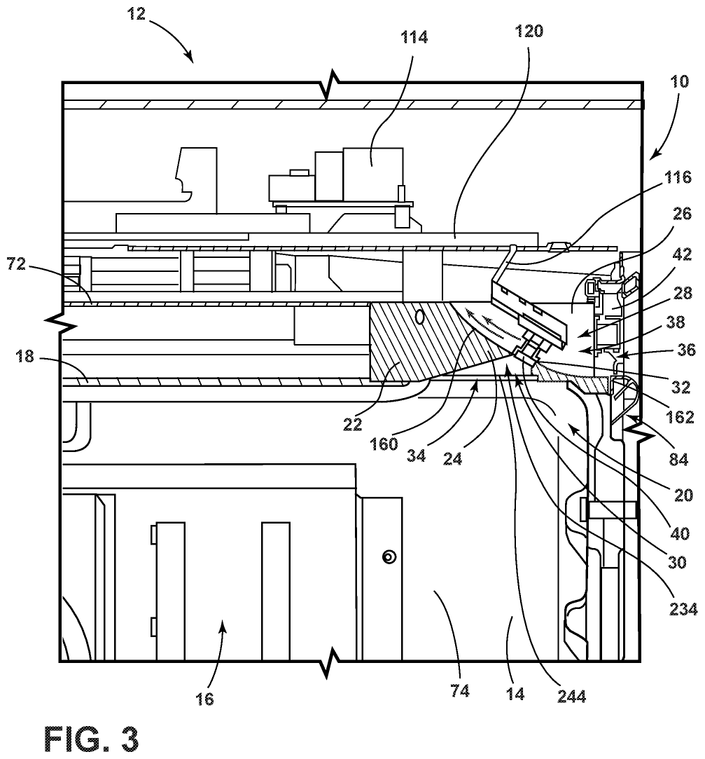

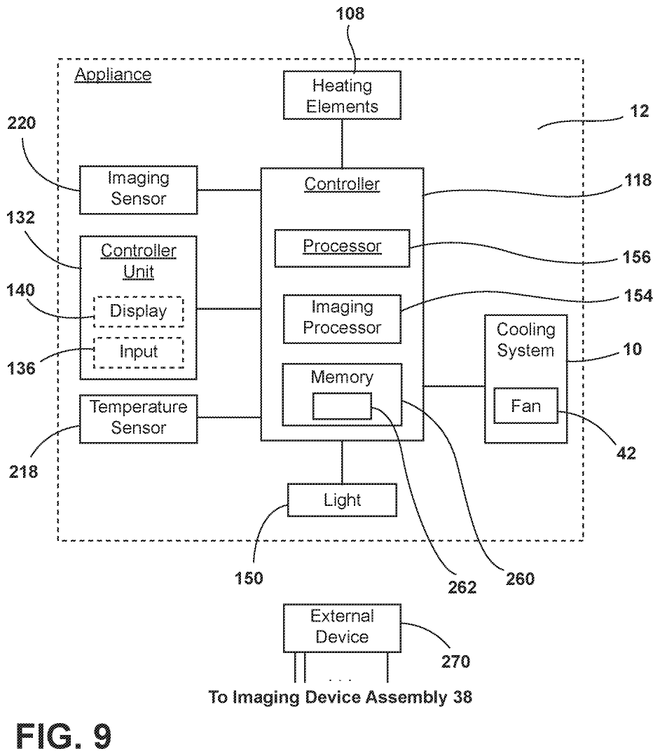

A top panel 58 having a perimeter wall 52 is operably coupled to the first and second side walls 64, 66 of the body 60 and extends over the upper wall 72 of the body 60. The top wall panel 58 and the upper wall 72 of the body 60 define an upper space 112 configured to receive electrical components 114 of the appliance 12. The electrical components 114 may include at least one controller 118 configured to control one or more processes of the cooking appliance 12 (FIG. 9). The electrical components 114 may be positioned on a plate 120 coupled to the upper wall 72 of the body 60 and may include conductive wires 116 extending to other portions of the cooking appliance 12 (FIG. 3).

In some examples, the body 60 may be positioned on one or more supports 82. The supports 82 may be positioned under the lower wall 70 of the body 60 as a central base or under the first and second side walls 64, 66 as feet for the appliance 12. In various examples, exterior panels 80 may extend from the top panel 58 to the bottom of the first and second side walls 64, 66. In other examples, the exterior panels 80 may extend from the top panel 58 to the supports 82 under the first and second side walls 64, 66.

The upper wall 72 of the body 60 defines a space 86 configured to receive the supporting member 22. The space 86 may be proximate either of the first or second side walls 64, 66 such that the supporting member 22 may be positioned by an exterior aperture 88 of the respective first or second side wall 64, 66. According to various examples, the exterior aperture 88 of the first or second side wall 64, 66 may be in communication with a side channel 84 defined at least partially by the first or second side wall 64, 66 and one of the exterior panels 80. Where the exterior panel 80 defines the side channel 84 for pulling air through to the supporting member 22, the exterior panel 80 and side channel 84 may act as a suction tower for the cooling system 10.

The casing 14 is positioned within the body cavity 78 of the body 60. The casing 14 includes first and second side walls 90, 92 joined by the top wall 18 and a bottom wall 94. The casing 14 defines the cooking cavity 16 and may be insulated. The cooking cavity 16 is selectively closeable by a door 98 having a handle 100. Each of the first and second side walls 90, 92 may further define a plurality of guides 104 for receiving cooking racks 106. Heating elements 108 may be positioned on the top wall 18 and/or the bottom wall 94 of the casing 14 and may be configured as bake and/or broil elements.

A front panel 124 may be positioned around the casing 14 to conceal the interior of the top panel 58 and the body 60. The front panel 124 may define a space 122 configured to align with the cooking cavity 16. A rim 126 of the front panel 124 may be configured to facilitate sealing the door 98 when the door 98 is in a closed position. The front panel 124 may further define a plurality of vents 128 positioned at the top of the panel 124 to vent the upper space 112 and aid in cooling the upper space 112. The front panel 124 may include other features for sealing the door 98 such as, for example, a hinge mount, a latch, a gasket seal, or a sensor.

A control panel 132 may be positioned above the front panel 124 and include a plurality of control inputs 136 for the cooking appliance 12. The control inputs 136 may comprise tactile keys, membrane switches, toggle switches, buttons, dials, slides or other suitable control mechanisms. According to various examples, the user may utilize the controls inputs 136 to select a food type, cooking configuration, and desired operation (e.g., broiling, baking, etc.) to be executed by the cooking appliance 12. The control panel 132 may further include a display element 140 and an audio device 144 configured to indicate information provided from the controller 118 (FIG. 9). In various examples, the display element 140 may provide a variety of messages, graphical icons, and other indicators to inform the user of the status of the cooking appliance 12. The audio device 144 may output audible signals (e.g., a “beep”) to alert the user to a condition of the cooking appliance 12 or to prompt the user to take an action relating to an operation of the cooking appliance 12. It will be understood that the positioning of the control inputs 136, the display element 140, and the audio device 144 is exemplary only and may be interchanged without departing from the scope of the present disclosure. It will also be understood that the audio device 144 may be located within the cooking appliance 12 in various examples.

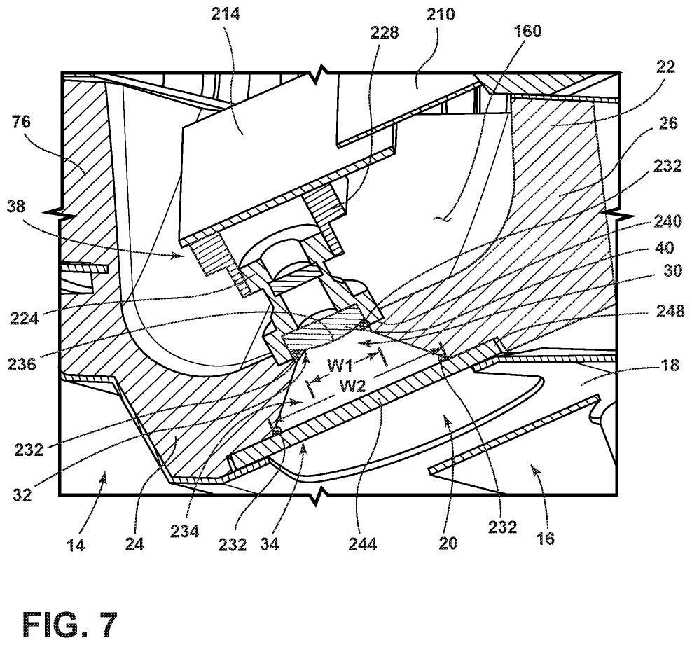

Referring now to FIGS. 2 and 3, the top wall 18 defines the aperture 20. According to various examples, the aperture 20 may be circular. In other examples, the aperture 20 may be oval, oblong, triangular, square, rectangular, or other higher order polygons to provide a desired range of vision for the imaging device assembly 38 (see FIGS. 3 and 7). The aperture 20 is defined such that the aperture 20 is at least partially aligned with the space 86 of the upper wall 72 of the body 60.

A light source 150 may be positioned within the casing 14 to illuminate the cooking cavity 16. In various examples, the light source 150 may be implemented within the cooking cavity 16 apart independent of the imaging device assembly 38, as shown in FIG. 2. Alternatively, the light source 150 may be implemented together with the imaging device assembly 38. When more than one light source 150 is used, it is contemplated that one or more of the light sources 150 may be implemented together with the imaging device assembly 38 while other light sources 150 are implemented independently of the imaging device assembly 38. Any number of the same or different type(s) of light sources 150 may be implemented. In some examples, the light sources 150 are light-emitting diodes (LEDs). Alternatively, fluorescent, incandescent, halogen, or any combination(s) of light sources may be used.

Referring now to FIG. 3, the supporting member 22 is positioned above the aperture 20 such that the supporting member 22 is operably coupled to and at least partially supported by the top wall 18 of the casing 14. The supporting member 22 may be at least partially formed of a thermally insulating material such as, for example, fiberglass or alkaline earth silicate fibers.

The supporting member 22 includes the bottom wall 24 and the perimeter wall 26. Together, the bottom wall 24 and the perimeter wall 26 define the air channel 28 configured to at least partially receive the imaging device assembly 38. The bottom wall 24 may further include a inner surface 160. According to various examples, the inner surface 160 may extend upward a first end 162 of the bottom wall 24 at a predetermined slope. The slope is selected to provide optimum airflow circulation through the air channel 28 of the supporting member 22 along the inner surface 160 and across the imaging device assembly 38. The inner surface 160 may also be curved when viewed from the first end 162 of the bottom wall 24, creating a semi-circular cross-section. In other examples, the inner surface 160 may be linear without curvature. In various examples, the inner surface 160 may further be coated by a thermally conductive material. In other examples, the inner surface 160 may be formed of a thermally conductive material and separate from the supporting member 22.

The lower side of the bottom wall 24 of the supporting member 22 defines the chamber 30. According to various examples, the chamber 30 includes a peripheral wall, the first opening 32, and the second opening 34. The supporting member 22 is positioned such that the first opening 32 of the chamber 30 is aligned with the aperture 20 defined by the top wall 18 of the casing 14. The first opening 32 is configured to receive the lens 40 of the imaging device assembly 38, and the second opening 34 is configured to receive a transparent member 244, as discussed elsewhere herein. When the lens 40 and the transparent member 244 are positioned within the first and second openings 32, 34, respectively, the chamber 30 defines a gap 234 for added insulation of the supporting member 22 and imaging device assembly 38. The gap 234 is sealed by the lens 40 and the transparent member 244 and may be airtight to prevent any significant airflow and improve insulating properties of the gap 234. It will be understood that the gap 234 may have a gas pressure less than 1 ATM or include a gas having a low thermal conductivity such as, for example, air. According to various examples, the gap 234 may have a height comprised between about 2 mm to about 30 mm. In other examples, the height of the gap 234 may be between about 5 mm and about 15 mm. This may reduce convective motion of the air inside the chamber 30 and also may reduce heat transmission other than convective between the cooking cavity 16 and the lens 40 of the imaging device assembly 38.

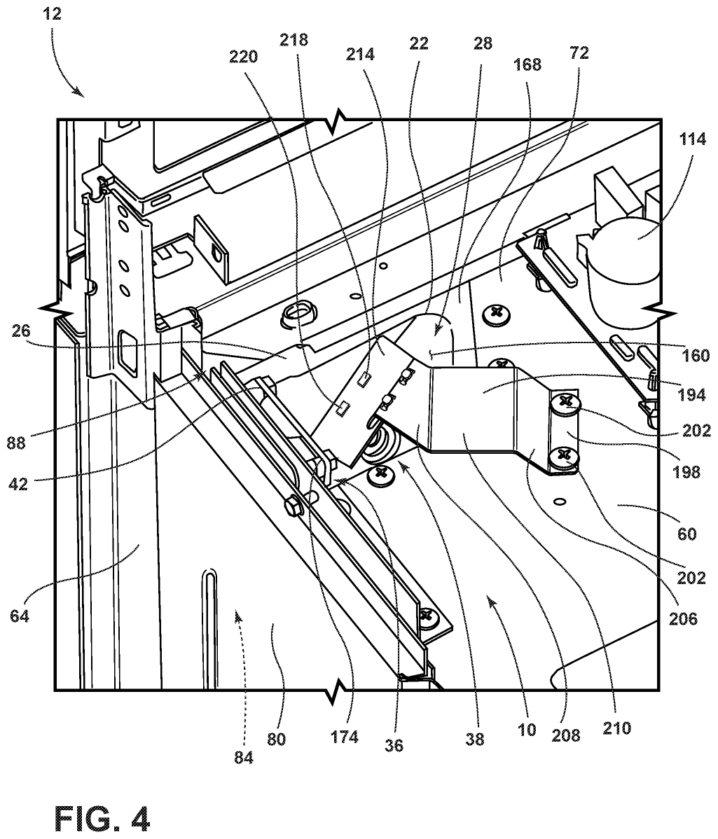

Referring now to FIGS. 4-6, the perimeter wall 26 of the supporting member 22 includes an upper edge 168 aligned so that the upper edge 168 is substantially flush with the upper wall 72 of the body 60. The perimeter wall 26 defines the opening 36 configured to receive the fan 42 of the cooling system 10. The opening 36 may be aligned with the exterior aperture 88 of the side wall 64, 66 such that the fan 42 is at least partially received by both the opening 36 of the supporting member 22 and the exterior aperture 88 of the side wall 64, 66.

According to various examples, the fan 42 includes a fan housing 174 that may be positioned within the opening 36 of the perimeter wall 26 of the supporting member 22. The fan housing 174 defines an opening 178 configured to receive a plurality of fan blades 182. The plurality of fan blades 182 are supported on a rotatable fan shaft 186 extending through the center of the fan housing 174 and at least partially supported by the fan housing 174. A center axis of the fan 42 is defined by the rotatable fan shaft 186. In various examples, the fan shaft 186 may be rotatable in one of or both of a clockwise and counterclockwise direction. In other examples, the fan 42 and/or the fan housing 174 may be detached from the supporting member 22.

A bell mouth inlet 190 may be positioned within the opening 36 of the perimeter wall 26 of the supporting member 22 and coupled to the supporting member 22. As used herein, a bell mouth inlet 190 refers to an inlet having an entry aperture and an exit aperture wherein the entry aperture has a larger cross-sectional area than the exit aperture. The differing sizes of the entry aperture and the exit aperture allow air to flow through the entry aperture to the exit aperture while minimizing the airflow in the opposite direction, preventing airflow loss. According to various examples, the bell mouth inlet 190 may be coupled to the fan 42 to allow the fan 42 to draw the maximum amount of air into the air channel 28 of the supporting member 22 with a minimum amount of air loss. The fan 42 and the bell mouth inlet 190 are further in communication with the side channel 84 defined by one of the exterior panels 80 and the side wall 64, 66 of the body 60 of the appliance 12. The side channel 84 allows air to be pulled upward through the side channel 84 by the fan 42 and into the side channel 28 of the supporting member 22. The airflow is guided and distributed by the inner surface 160 of the bottom wall 24 of the supporting member 22 to provide an air flow pattern for cooling the imaging device assembly 38.

The fan 42 may be positioned within a lip 172 surrounding the periphery of the opening 36 of the perimeter wall 26 of the supporting member 22. Alternatively, the fan 42 may be positioned to abut the perimeter wall 26 and the bottom wall 24 of the supporting member 22 at the first end 162 of the bottom wall 24. In various examples, the fan 42 may be coupled to the opening 36 by a plurality of fasteners 170. In other examples, the fan 42 may be operably coupled to the side wall 64, 66 of the body 60 of the appliance 12. In still other examples, the bell mouth inlet 190 may be coupled to the side wall 64, 66 of the body 60 of the appliance 12, and the fan 42 may be coupled to the bell mouth inlet 190. The fan 42 is configured to provide airflow across the imaging device assembly 38.

Still referring to FIGS. 4-6, a bracket 194 may be operably coupled to either the upper wall 72 of the body 60 of the appliance 12 or the upper edge 168 of the perimeter wall 26 of the supporting member 22. The bracket 194 includes a foot 198. A plurality of fasteners 202 may be used to couple the bracket 194 to the upper wall 72 of the body 60 and/or the upper edge 168 of the perimeter wall 26. The bracket 194 further includes a first inclined portion 206 extending upward from the foot 198. A body portion 210 extends from the first inclined portion 206 over the air channel 28 defined by the supporting member 22. According to various examples, the body portion 210 may include a second inclined portion 208 extending downward toward the air channel 28. The bracket 194 may be coupled to the upper wall 72 or the upper edge 168 using adhesive, welding, or bolts, for example. The bracket 194 may be formed of a metallic conductive material such as, for example, copper, or any other conductive material.

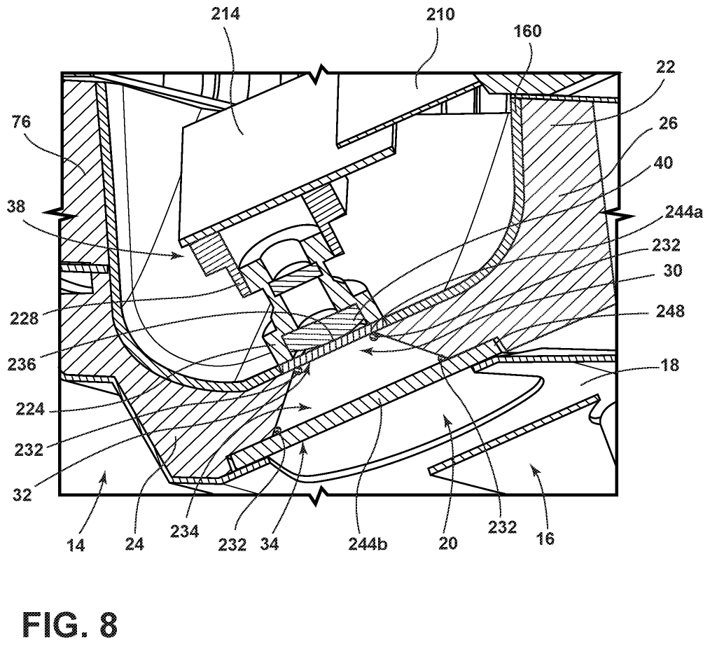

Referring now to FIGS. 7 and 8, the imaging device assembly 38 may be coupled to the bracket 194. The imaging device assembly 38 may include a printed circuit board (PCB) 214, an imaging sensor 220, a lens barrel 224, a lens holder 228 coupled with the lens barrel 224, and the lens 40. The imaging device assembly 38 may further include a camera barrel of any material coupled to at least the lens barrel 224. According to various examples, one of the lens barrel 224 and the camera barrel may be thermal conductive.

The imaging device assembly 38 is positioned so that the lens 40 of the imaging device assembly 38 is aligned with the first opening 32 of the chamber 30 and the aperture 20 defined by the top wall 18 of the casing 14 to allow the imaging device assembly 38 to view the cooking cavity 16 of the casing 14. When installed, normally during manufacture, the imaging device assembly 38 becomes electrically and/or communicatively coupled to other components (e.g., the electrical components 114, the controller 118, and/or the control panel 132) of the cooking appliance 12 using any wired or wireless protocol, signal, component, switch, hub, router, etc., or any combination(s) thereof. Servos, motors, steppers, actuators, linear actuators, etc. may be used to move the imaging device assembly 38 in one or more directions during use. The imaging device assembly 38 may be a digital camera such as a charged/coupled device (CCD) camera or a complementary metal oxide semiconductor (CMOS) camera or any other form of device configured to create stationary images and/or a constant video stream. In various examples, the imaging device assembly 38 may be configured to sequentially take or capture images or pictures of the cooking cavity 16. According to other examples, the imaging device assembly 38 may be configured to record video of the cooking cavity 16.

As shown in FIGS. 4-8, the PCB 214 is positioned on and coupled to the body portion 210 of the bracket 194. The PCB 214 may be coupled to the second inclined portion 208 of the body portion 210 and positioned over and/or within the air channel 28 of the supporting member 22. The PCB 214 is positioned at an angle relative to the central axis of the fan 42 following the air flow generated by the fan 42. In various examples, a temperature sensor 218, an imaging sensor 220, and/or the imaging device assembly 38 may be positioned on the PCB 214. The PCB 214 may be electrically connected to the electrical components 114 of the cooking appliance 12, including, for example, the controller 118 and/or the control panel 132, by conductive wires 116 (see FIG. 3).

Referring again to FIGS. 7 and 8, the imaging device assembly 38 includes the lens barrel 224 to house the lens 40 and a lens holder 228 to support the lens 40 within the lens barrel 224. According to various examples, the lens barrel 224 and the lens holder 228 may be formed as a single part. In other examples, the lens barrel 224 may be separate from the lens holder 228.

According to various examples, the lens holder 228 may be formed of an alloy such as, for example, aluminum or copper. The lens holder 228 may be a threaded flange positioned proximate the PCB 214. The PCB 214 may at least partially support the lens holder 228. The lens holder 228 may be configured to receive and secure the lens 40 and/or the lens barrel 224 of the imaging device assembly 38. The inner surface 160 of the bottom wall 24 may include a first lip 240 configured to receive at least one of the lens barrel 224 and the lens 40 to ensure that the lens 40 is coupled to and substantially flush with the first opening 32 of the chamber 30.

According to various examples, a gasket 232 may be positioned proximate the first lip 240 and abutting the lens 40 to fully seal the first opening 32 of the chamber 30. For example, the gasket 232 may be positioned within the first lip 240. In other examples, the gasket 232 may be positioned about the first lip 240. In still other examples, the gasket 232 may be positioned along the inner edge of the first lip 240 and partially within the first opening 32 of the chamber 30. The chamber 30 is sealed such that gas within the chamber 30 is substantially still. More particularly, gas within the chamber has a velocity less than about 0.1 meters per second. The chamber 30 is designed to prevent or minimize substantial convective movement of the gas filling the chamber 30 itself.

The chamber 30 may have a generally conical cross-section. Each of the first and second openings 32, 34 may be generally circular in shape. The first opening 32 has a first diameter W1, and the second opening 34 has a second diameter W2. The first diameter W1 is less than the second diameter W2. According to various examples, the second diameter W2 may be less than the width of the aperture 20 defined by the top wall 18 of the casing 14. The widening of the chamber 30 from the first opening 32 to the second opening 34 provides the imaging device assembly 38 with a predetermined angle of view.

According to various examples, the lens 40 may be a single optical lens. In other examples, the lens 40 may include multiple optical lenses forming a plurality of lens 40. The lens 40 may include at least one curved surface 236 where the curved surface 236 is aligned with and at least partially received by the first opening 32 of the chamber 30 of the supporting member 22. In various examples, the lens 40 is formed of a glass or polymeric material. The imaging sensor may have a size of about 0.25 inches to about 0.5 inches. The lens 40 may have a focal length within a range of about 2 mm to about 5 mm or any value or range of values therebetween. It is contemplated that the lens 40 of the imaging device assembly 38 may have an adjustable focal length in various examples.

The transparent member 244 is received by a second lip 248 formed about the periphery of the second opening 34 of the chamber 30. The transparent member 244 is received by the second lip 248 and positioned over the second opening 34 of the chamber 30. In various examples, the transparent member 244 may be positioned within the second lip 248 so that the transparent member 244 is between the supporting member 22 and the top wall 18 of the casing 14. The transparent member 244 may have a diameter than is greater than the second diameter W2 such that the transparent member 244 fully covers and seals the second opening 34 of the chamber 30. In other examples, a pair of transparent members 244a, 244b (FIG. 8) may be used with each member 244a, 244b positioned proximate one of the first opening 32 and the second opening 34 and configured to seal the respective opening 32, 34. According to various examples, the transparent member 244a positioned over the first opening 32 may be used with the lens 40 or in place of the lens 40.

The transparent member 244 may have a thickness within a range of about 1 mm to about 10 mm, about 4 mm to about 6 mm, or any value or range of values therebetween. In some examples, the transparent member 244 may be formed of a glass-based material or any other material having a low thermal conductivity. The transparent member 244 may be configured to insulate the imaging device assembly 38 from heat generated by the cooking appliance 12. In various examples, the transparent member 244 may be treated with an anti-reflective coating to reduce heat radiation from the cooking cavity 16 to the lens 40. In other examples, the transparent member 244 may be treated with an infrared blocking or abating coating. In still other examples, the transparent member 244 may be treated with an anti-reflective coating to reduce light reflection from the cooking cavity 16 to the lens 40. It will be understood that the treatment may be applied to one or both the transparent members 244a, 244b without departing from the scope of the present disclosure. It will also be understood that the combinations shown of the above-referenced features including the lens 40, the lens barrel 224, the lens holder 228, the camera barrel, the gaskets 232, the first and second transparent member 244a, 244b, and so forth are exemplary only. Any combination of these features may be used without departing from the scope of the present disclosure.

Referring now to FIGS. 1-9, the controller 118 may direct the operation of one or more control elements of the cooking appliance 12. The controller 118 includes a memory 260 having instructions 262 stored thereon that are executable by a processor 266 and/or an imaging processor 268. The controller 118 may be part of or integrated with the control panel 132 or may be a separate unit. The control panel 132, as previously discussed, includes the plurality of control inputs 136 and the display element 140. The display element 140 may be, for example, a liquid crystal display (LCD) screen, a light-emitting diode (LED) display, or an organic light-emitting diode display (OLED).

The temperature sensor 218 may be connected with the controller 118. As shown in FIG. 4, the temperature sensor 218 may be positioned within the supporting member 22 and configured to provide temperature information to the controller 118 regarding the temperature of the air within the air channel 28 defined by the supporting member 22 to prevent overheating of the imaging device assembly 38. The controller 118 may be connected to the cooling system 10 configured to cool the air channel 28, such that when the temperature sensor 218 detects a temperature that could be damaging to the imaging device assembly 38, the cooling system 10 is activated.

During the operation of the cooking appliance 12, the cooling system 10 is also activated so that whenever the cooking appliance 12 is in operation, the imaging device assembly 38 is cooled. Additionally, the temperature sensor 218 may be used to sense temperature at all times, even when the cooking appliance 12 is not in operation, so that if the air channel 28 reaches a predetermined temperature, the cooling system 10 may be energized to cool the imaging device assembly 38. This may occur in the case where the imaging device assembly 38 is used in a cooking appliance 12 having a cook top. During operation of the cook top, heat from the cook top may elevate the temperature of the upper space 112 where the imaging device assembly 38 is located. In this situation, the cooling system 10 would be energized such that the fan 42 is activated to cool the imaging device assembly 38. The airflow would be generated over the lens barrel 224 and the lens holder 228 while the sealed openings 32, 34 of the chamber 30 would substantially avoid contact with any airflow generated by the fan 42, maintaining the sealed chamber 30 and the insulating properties of the air within the gap 234.

According to various examples, the control panel 132 may provide a communication message on the display element 140 when the cooling system 10 is operated independently of the cooking appliance 12. This message can communicate that the cooling system 10 of the cooking appliance 12 has been energized due to sensed high temperatures. It may be possible to instruct the user to confirm operation of the cook top and/or the cooking appliance 12 to ensure proper operation or to take steps to reduce the temperature within the air channel 28 of the supporting member 22.

The control inputs 136 of the control panel 132 may provide user input to the controller 118 regarding various operations of the appliance 12. The input and respective instructions 262 may generally relate to ways in which to operate, for example, the heating elements 108, the imaging device assembly 38, and/or the light source 150. For example, the instructions 262 may relate to the activation of the heating elements 108 to reach a desired temperature based on user input. In other examples, the instructions 262 may relate to features of the imaging device assembly 38 including capturing images and/or adjusting the imaging device assembly 38. For example, user input may be used to adjust the focal length of the imaging device assembly 38. In still other examples, the instructions 262 may relate to activating the light source 150 positioned within the cooking cavity 16. The controller 118 may activate the light source 150 based on user input directly related to the light source 150 or may activate the light source 150 in response to user input regarding the imaging device assembly 38.

In various examples, the controller 118 may be configured to send the images from the imaging device assembly 38 to an external device 270, such as a smartphone or laptop. Other example external devices 270 include, but are not limited to, a personal computer (PC), a workstation, a residential gateway, a set-top box, a netbook, a tablet PC, a smart watch, a media player, a game console, and/or any other type of computing device containing a processor. Similarly, the controller 118 may be configured to receive information from the external device 270. For example, the user may activate the cooling system 10 remotely. In other examples, the controller 118 may be configured to provide information to the external device 270, similarly to the display element 140, as discussed above. For example, the user may receive notifications that the cooling system 10 of the cooking appliance 12 has been activated and/or confirm use of the cooking appliance 12.

The cooling system 10 provides the airflow pattern to cool the imaging device assembly 38 when the cooking appliance 12 reaches predetermined temperatures. The airflow pattern is at least partially determined by the slope and curvature of the inner surface 160 of the supporting member 22. The supporting member 22 is further formed of insulating material to better protect the imaging device assembly 38 from heat generated by the cooking appliance 12. This allows the imaging device assembly 38 to be used to transmit images of the cooking cavity 16 to the display element 140 or the external device 270, preventing the user from having to open the door 98 of the cooking appliance 12 to view the cooking cavity 16.

According to one aspect, a cooking appliance may be provided that may include a casing defining a cooking cavity. The casing may include a top wall defining an aperture. An imaging device assembly may be configured to take imagery of the cavity interior. The imaging device assembly may include an imaging sensor and a plurality of lenses supported by a lens holder. The imaging device assembly may be positioned so as to see through the aperture. A supporting member may be at least partially made of an insulating material and defines a chamber having a peripheral wall, a first opening, and a second opening. The second opening may be opposite the first opening. The lens holder may be positioned proximate the first opening so that the plurality of lenses face the chamber. At least one transparent member may be mounted at the second opening and may be configured to seal the chamber relative to the cooking cavity. A fan may be coupled to the casing proximate the aperture in the top wall. The fan may be configured to selectively supply an airflow towards the lens holder of the imaging device assembly.

According to still other aspects, a distance from the first opening and the second opening of the chamber may be between about 2 mm and about 30 mm.

According to yet another aspect, a distance from the first opening and the second opening of the chamber may be between about 5 mm and about 15 mm.

According to still another aspect, a gasket may be arranged at one of the first opening and the second opening of the chamber. The gasket may abut one of the plurality of lens and the transparent member, respectively.

According to other aspects, an inner surface of the supporting member may include a straight portion in fluid communication with the fan and a curved portion contiguous to the straight portion.

According to another aspect, an inner surface of the supporting member may include a thermally conductive material.

According to still other aspects, the transparent member may include an infrared blocking coating.

According to yet another aspect, the chamber may be filled with an inert gas. The inert gas may be substantially still and may have a velocity less than about 0.1 meters per second.

According to still another aspect, the chamber is designed to prevent or minimize substantial convective movement of the gas filling the chamber itself.

According to another aspect, the chamber may be vacuum sealed.

According to still other aspects, the cooking appliance may further include a bell mouth inlet positioned upstream of the fan relative to a direction of the airflow from the fan.

According to yet another aspect, a cooking appliance may be provided that includes a casing defining a cooking cavity. The casing includes a top wall defining an aperture. A supporting member may have a bottom wall with an inner surface and a perimeter wall at least partially integrally formed with the bottom wall. The bottom wall may define a vacuum-sealed chamber with a first opening and a second opening. The second opening may be aligned with the aperture of the top wall of the casing. A fan may be coupled to the supporting member and may be configured to selectively supply the airflow along the inner surface. An imaging device assembly may be positioned within the air channel of the supporting member such that a lens of the imaging device assembly may be aligned with the first opening of the chamber to view the cavity. The imaging device assembly may be at least partially supported by a bracket.

According to other aspects, the imaging device assembly may include a printed circuit board coupled with the bracket and having an imaging sensor and at least one barrel coupled with the printed circuit board. The at least one barrel may include one of a camera barrel and a lens barrel. The lens barrel may house the lens.

According to still other aspects, the first opening may have a first width and the second opening may have a second width. The second width may be greater than the first width.

According to another aspect, the cooking appliance may further include a transparent member positioned over the second opening. The transparent member may include an anti-reflective coating. The transparent member may have a third width. The third width may be greater than a second width of the second opening.

According to another aspect, a cooking appliance may be provided that may include a casing defining a cooking cavity. The casing may include a top wall defining an aperture. A supporting member may have an inner surface and may define an air channel and a sealed chamber with a first opening and a second opening. The second opening may be aligned with the aperture of the top wall of the casing. A fan may be coupled to the casing and may be configured to selectively supply airflow along the inner surface. An imaging device assembly may be positioned within the air channel of the supporting member and may be aligned with the first opening of the chamber to view the cavity. The imaging device assembly may be configured to seal the first opening. A transparent member may be positioned proximate the second opening and may be configured to seal the second opening.

According to other aspects, the inner surface of the housing may include a straight portion in fluid communication with the fan and a curved portion contiguous to the straight portion.

According to another aspect, the cooking appliance may further include a second transparent member positioned proximate the first opening and configured to seal the first opening.

According to yet another aspect, the imaging device may include a lens barrel.

According to still other aspects, the cooking appliance may further include a gasket. The gasket may be positioned about a periphery of one of the first opening and the second opening and may be configured to further seal the respective opening.

According to yet another aspect, the imaging device assembly may include a printed circuit board operably coupled to a bracket. The bracket may extend at least partially into the air channel to position the printed circuit board within the air channel at a predetermined angle relative to the fan. A lens holder may be operably coupled to the printed circuit board. The lens holder may be threaded. A lens barrel may have a first end and a second end. The lens barrel may be operably coupled to the lens holder at the first end. A lens may be coupled to the lens barrel at the second end.

According to still another aspect, imaging device assembly may include a camera barrel. One of the camera barrel and the lens barrel may be thermally conductive.

According to other aspects, the chamber may be filled with an inert gas. The airflow generated by the fan may be prevented from the entering the chamber by the sealing of the first and second openings.

It will be understood by one having ordinary skill in the art that construction of the described concepts, and other components, is not limited to any specific material. Other exemplary embodiments of the concepts disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A cooking appliance, comprising:
a casing defining a cooking cavity, wherein the casing includes a top wall defining an aperture;
an imaging device assembly configured to take imagery of the cavity interior, the imaging device assembly comprising an imaging sensor and a plurality of lenses supported by a lens holder, wherein the imaging device assembly is positioned so as to see through the aperture;
a supporting member at least partially made of an insulating material and defining a chamber having a peripheral wall, a first opening, and a second opening, wherein the second opening is opposite the first opening, and wherein the lens holder is positioned proximate the first opening so that the plurality of lenses face the chamber, and further wherein at least one transparent member is mounted at the second opening and configured to seal the chamber relative to the cooking cavity; and
a fan coupled to the casing proximate the aperture in the top wall, the fan configured to selectively supply an airflow towards the lens holder of the imaging device assembly.

2. The cooking appliance of claim 1, wherein a distance from the first opening and the second opening of the chamber is between about 2 mm and about 30 mm.

3. The cooking appliance of claim 2, wherein the distance from the first opening and the second opening of the chamber is between about 5 mm and about 15 mm.

4. The cooking appliance of claim 1, wherein a gasket is arranged at one of the first opening and the second opening of the chamber, the gasket abutting one of the plurality of lens and the transparent member, respectively.

5. The cooking appliance of claim 1, wherein an inner surface of the supporting member comprises a straight portion in fluid communication with the fan and a curved portion contiguous to the straight portion.

6. The cooking appliance of claim 5, wherein the inner surface of the supporting member includes a thermally conductive material.

7. The cooking appliance of claim 1, wherein the transparent member includes an infrared blocking coating.

8. The cooking appliance of claim 1, wherein the chamber is filled with an inert gas, and further wherein the inert gas is substantially still, the inert gas having a velocity less than about 0.1 meters per second.

9. The cooking appliance of claim 1, wherein the chamber is sealed.

10. The cooking appliance of claim 1, further comprising:
a bell mouth inlet positioned upstream of the fan relative to a direction of the airflow from the fan.

11. A cooking appliance, comprising:
a casing defining a cooking cavity, wherein the casing includes a top wall defining an aperture;
a supporting member defining an air channel and having a bottom wall with an inner surface and a perimeter wall at least partially integrally formed with the bottom wall, wherein the bottom wall defines a vacuum-sealed chamber with a first opening and a second opening, the second opening aligned with the aperture of the top wall of the casing;
a fan coupled to the supporting member and configured to selectively supply an airflow along the inner surface; and
an imaging device assembly positioned within the air channel of the supporting member such that a lens of the imaging device assembly is aligned with the first opening of the chamber to view the cavity, the imaging device assembly at least partially supported by a bracket.

12. The cooking appliance of claim 11, wherein the imaging device assembly comprises:
a printed circuit board coupled with the bracket and having an imaging sensor; and
at least one barrel coupled with the printed circuit board, wherein the at least one barrel includes one of a camera barrel and a lens barrel, and further wherein the lens barrel houses the lens.

13. The cooking appliance of claim 11, wherein the first opening has a first width and the second opening has a second width, and further wherein the second width is greater than the first width.

14. The cooking appliance of claim 11, further comprising:
a transparent member positioned over the second opening, wherein the transparent member includes an anti-reflective coating, and further wherein the transparent member has a third width, the third width being greater than a second width of the second opening.

15. A cooking appliance, comprising:
a casing defining a cooking cavity, wherein the casing includes a top wall defining an aperture;
a supporting member having an inner surface and defining an air channel and a sealed chamber with a first opening and a second opening, the second opening aligned with the aperture of the top wall of the casing;
a fan coupled to the casing and configured to selectively supply airflow along the inner surface;
an imaging device assembly positioned within the air channel of the supporting member and aligned with the first opening of the chamber to view the cavity, the imaging device assembly configured to seal the first opening; and
a first transparent member positioned proximate the second opening and configured to seal the second opening.

16. The cooking appliance of claim 15, further comprising:
a second transparent member positioned proximate the first opening and configured to seal the first opening.

17. The cooking appliance of claim 15, further comprising:
a gasket, wherein the gasket is positioned about a periphery of one of the first opening and the second opening and is configured to further seal the respective opening.

18. The cooking appliance of claim 15, wherein the imaging device assembly comprises:
a printed circuit board operably coupled to a bracket, wherein the bracket extends at least partially into the air channel to position the printed circuit board within the air channel at a predetermined angle relative to the fan;
a lens holder operably coupled to the printed circuit board, wherein the lens holder is threaded;
a lens barrel having a first end and a second end, wherein the lens barrel is operably coupled to the lens holder at the first end; and
a lens coupled to the lens barrel at the second end.

19. The cooking appliance of claim 18, wherein the imaging device assembly further comprises:
a camera barrel, and further wherein one of the camera barrel and the lens barrel is thermally conductive.

20. The cooking appliance of claim 15, wherein the chamber is filled with an inert gas, and further wherein the airflow generated by the fan is prevented from entering the chamber by the sealing of the first and second openings.
